(19) United States
(12) Patent Application Publication
(10) Pub. No.: US 2012/0138799 A1
(43) Pub. Date: Jun. 7, 2012

(54) INFRARED DETECTION ELEMENT AND INFRARED IMAGING DEVICE

(75) Inventors: Minoru Wakabayashi, Tokyo (JP); Hidetoshi Kabasawa, Saitama (JP); Masahiro Saito, Kanagawa (JP)

(73) Assignee: SONY CORPORATION, Tokyo (JP)

(21) Appl. No.: 13/289,187

(22) Filed: Nov. 4, 2011

(30) Foreign Application Priority Data
Dec. 7, 2010 (JP) P2010-272154

(51) Int. Cl. G01J 5/10

(52) U.S. Cl. 250/338.3

(57) ABSTRACT

An infrared detection element includes a pyroelectric element, an upper electrode and a lower electrode located so as to have a positional relationship where the pyroelectric element is interposed therebetween, and an opening function portion formed on the upper electrode such that a film thickness of the upper electrode is small or zero.

### CROSS REFERENCES TO RELATED APPLICATIONS

The present application claims priority to Japanese Priority Patent Application JP 2010-272154 filed in the Japan Patent Office on Dec. 7, 2010, the entire content of which is hereby incorporated by reference.

### BACKGROUND

The present application relates to an infrared detection element which receives and detects infrared rays and particularly is very suitable to be applied to a pyroelectric type infrared detection element which generates surface charge due to a variation in spontaneous polarization. In addition, the present application relates to an infrared imaging device which includes the infrared detection element and obtains an infrared captured image.

An infrared detection element which detects sensed infrared rays is largely classified into two kinds of a so-called quantum type and thermal type.

Of the two, the thermal type infrared detection element which absorbs incident infrared rays and detects the infrared rays through a variation in temperature of the infrared rays has an advantage in that cooling is not necessary. For this reason, in recent years, the thermal type infrared detection element has been used as an imager of the infrared imaging device (thermography), or a motion sensor mounted in an eco-product or the like.

The thermal type infrared detection element has, for example, the following three types. One is a thermopile type to which a thermocouple causing the Seebeck effect is connected. Another is a bolometer type using a variation in a resistance value due to a temperature increase. The other is a pyroelectric type which generates surface charge due to a variation in spontaneous polarization of a pyroelectric element.

Among them, in relation to the pyroelectric type infrared detection element, in order to heighten sensitivity for infrared rays, research for heightening a pyroelectric coefficient which is generation efficiency of surface charge due to a temperature variation, and research for efficiently absorbing incident infrared rays is being actively performed through a study of kinds of pyroelectric materials or combinations thereof.

For example, Japanese Patent No. 3944465 discloses a cavity structure in which, as shown in FIG. 15, an infrared absorption portion 101 is floated over a temperature sensor 103 using a supporting leg 104 on a substrate 105.

This is to increase the area of the infrared absorption portion 101 as much as possible by independently arranging the infrared absorption portion 101 using the supporting leg 104. That is to say, a ratio of the detectable sensor area to the area of the pixel region is made to be increased.

In addition, Japanese Unexamined Patent Application Publication No. 2008-51522 discloses that an infrared absorption layer 113 including an infrared absorption film 110, a subsidiary reflection film 111, and a metal reflection film (infrared reflection film) 112, is formed on the upper layer side of a diode 114 which is an infrared detection portion, as shown in FIG. 16. In the infrared absorption layer 113, infrared rays passing through the uppermost infrared absorption film 110 are reflected by the lowermost infrared reflection film 112, such that the infrared rays return to the infrared absorption film 110, thereby heightening absorption efficiency of the infrared rays.

### SUMMARY

Here, in Japanese Patent No. 3944465, the infrared absorption portion 101 is supported by the supporting leg 104 so as to be floated in air. In a semiconductor process of this structure, steps are necessary in which a material for forming the supporting leg 104 is formed once (referred to as a supporting leg layer), then the infrared absorption portion 101 is formed, and unnecessary parts other than parts which will be the supporting leg 104 are removed from the supporting leg layer through etching, and thus the structure causes the process to be complicated.

In addition, in Japanese Patent No. 3944465, the temperature sensor 103 which is connected to the infrared absorption portion 101 via the supporting leg 104 detects the actual temperature. It is disclosed that a diode or a transistor is used as the temperature sensor 103, and infrared rays are detected through variations in electric characteristics of the diode or the transistor due to variations in temperature.

As can be seen from this, in the configuration in Japanese Patent No. 3944465, it is necessary to send heat obtained by the infrared absorption portion 101 absorbing infrared rays, to the temperature sensor 103 via the supporting leg 104. That is to say, the heat obtained by the absorption of infrared rays is not entirely used to increase the temperature of the temperature sensor 103, and thus loss occurs in an amount corresponding to a temperature increase at the infrared absorption portion 101 and the supporting leg 104, in other words, the heat capacity of the infrared absorption portion 101 and the supporting leg 104.

As a result, use efficiency of incident infrared energy tends to be reduced.

In addition, in the above-described structure, there is also a problem in that conduction of heat to the sensor is delayed.

Further, in Japanese Unexamined Patent Application Publication No. 2008-51522 as well, it is necessary to form the infrared reflection film 112 and the infrared absorption film 110 on the diode 114 which is an infrared detection portion, and thus a manufacturing process is complicated.

In addition, there is also a problem in that loss corresponding to heat capacity of the infrared absorption film 110 and the reflection film 112 occurs.

It is desirable to implement a high sensitivity infrared detection element which can absorb incident infrared rays with good efficiency and effectively use the obtained infrared energy with a simple structure without a complicated manufacturing process.

An infrared detection element according to an embodiment has the following configuration.

That is to say, the infrared detection element includes a pyroelectric element; an upper electrode and a lower electrode located so as to have a positional relationship where the pyroelectric element is interposed therebetween; and an opening function portion formed on the upper electrode such that a film thickness of the upper electrode is small or zero.

In addition, an imaging device according to another embodiment has the following configuration.

That is to say, the imaging device includes an imaging element that includes a plurality of infrared detection elements which are arranged in an imaging surface; and an imaging optical system that collects infrared rays at the imaging surface.

Further, the imaging device includes the an image signal obtaining unit that obtains an infrared captured image signal based on a result of detecting electric charge obtained by the infrared detection element according to the collection of the infrared rays.

Here, the infrared detection element of the imaging element includes a pyroelectric element; an upper electrode and a lower electrode located so as to have a positional relationship where the pyroelectric element is interposed therebetween; and an opening function portion formed on the upper electrode such that a film thickness of the upper electrode is small or zero.

As described above, in the embodiments, there is provided the opening function portion formed on the upper electrode such that a film thickness of the upper electrode is small or zero. Since transmittance of infrared rays in the opening function portion is increased, an amount of the infrared rays transmitted to the pyroelectric element side can be increased accordingly. As a result, it is possible to improve infrared detection sensitivity.

In addition, since the opening function portion is formed only by enabling the thickness of the upper electrode to be small or zero, it is possible to prevent a manufacturing process of an infrared detection element realizing high sensitivity from being complicated.

According to the embodiments, it is possible to implement a high sensitivity infrared detection element while preventing a manufacturing process thereof from being complicated.

Additional features and advantages are described herein, and will be apparent from the following Detailed Description and the figures.

### BRIEF DESCRIPTION OF THE FIGURES

FIG. 1 is a block diagram illustrating an internal configuration of an imaging device according to an embodiment.

FIG. 2 is a perspective view illustrating a structure of an infrared detection element according to a first embodiment.

FIG. 3 is a cross-sectional structure view of the infrared detection element according to the first embodiment.

FIG. 4 is a plan view illustrating a structure of an imager.

FIGS. 5A and 5B are diagrams schematically illustrating forms of transmission and reflection of infrared rays depending on presence and absence of an opening portion.

FIGS. 6A and 6B are diagrams schematically illustrating forms of heat conduction depending on presence and absence of the opening portion.

FIG. 7 is a diagram illustrating a relationship between an opening ratio, and transmittance and reflectance of infrared rays as a table.

FIG. 8 is a diagram illustrating a relationship between a temperature variation ratio and an output ratio with respect to the opening ratio.

FIG. 9 is a cross-sectional structure view of an infrared detection element according to a second embodiment.

FIG. 10 is a cross-sectional structure view of an infrared detection element according to a third embodiment.

FIG. 11 is a cross-sectional structure view of an infrared detection element according to a modified example 1.

FIGS. 12A to 12F are diagrams illustrating shape modifications of the opening portion.

FIGS. 13A and 13B are diagrams illustrating a structure of an infrared detection element according to a modified example 2.

FIG. 14 is a cross-sectional structure view of an infrared detection element according to a modified example 3.

FIG. 15 is a diagram illustrating a structure of an infrared detection element having a supporting leg in the related art.

FIG. 16 is a diagram illustrating a structure of an infrared detection element having an infrared absorption layer in the related art.

### DETAILED DESCRIPTION

Hereinafter, embodiments of the present disclosure will be described.

The description will be made in the following order.
1. FIRST EMBODIMENT
1-1. CONFIGURATION OF IMAGING DEVICE
1-2. STRUCTURE OF INFRARED DETECTION ELEMENT AND IMAGER
1-3. OPERATION AND EFFECTS
2. SECOND EMBODIMENT
3. THIRD EMBODIMENT
4. MODIFIED EXAMPLE

### 1. FIRST EMBODIMENT

### 1-1. CONFIGURATION OF IMAGING DEVICE

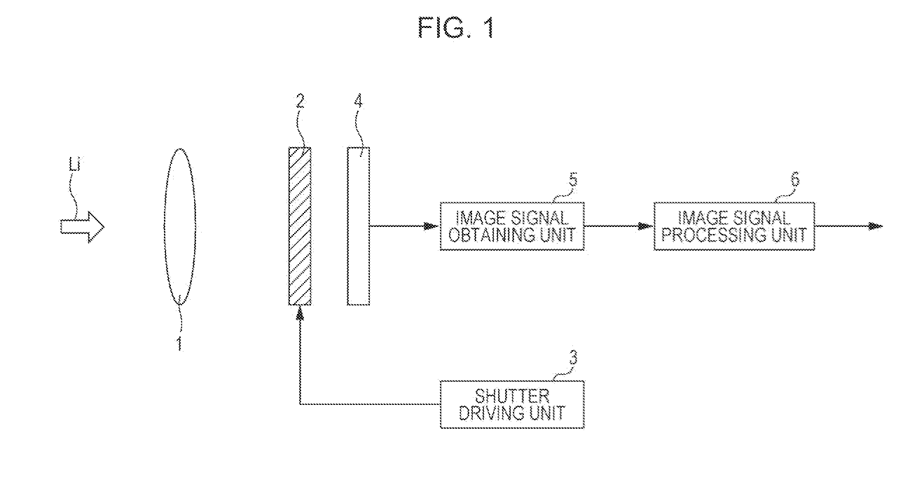

FIG. 1 is a block diagram illustrating an internal configuration of an imaging device according to an embodiment (hereinafter, referred to as an imaging device according to an embodiment).

In FIG. 1, the imaging device according to an embodiment includes an imaging lens 1. The imaging lens 1 collects infrared rays from a subject, indicated by incident light Li in the figure, at an imaging surface of an imager 4.

The material of the imaging lens 1 is not particularly limited as long as it transmits infrared rays therethrough. For example, in addition to a Ge lens or a Si lens which has been proposed in the related art, a lens which is made of a material cheaper than the material of the lens in the related art and can transmit infrared rays therethrough may be used. In addition, lens materials for infrared rays which will be developed in the future may be used.

Further, an optical system for collecting infrared rays at the imager 4 practically includes a plurality of lenses; however, only the imaging lens 1 is extracted and shown for simplicity of the description.

A shutter 2 and a shutter driving unit 3 are installed such that application and blocking of infrared rays from a subject to the imager 4 are alternately repeated.

For example, the shutter 2 may use a shutter including a blocking member (made of a material which blocks infrared rays from a subject) and an actuator which maintains the blocking member so as to be displaced. In this case, the shutter driving unit 3 may control driving of the actuator, and thereby application and blocking of infrared rays to the imager 4 may be repeated.

Alternatively, the shutter 2 may include an opening and closing switching setting element such as a liquid crystal shutter, and, in this case, the shutter driving unit 3 electrically controls an opened state and a closed state of the opening and closing switching setting element, and thereby application and blocking of infrared rays to the imager 4 are repeated.

Here, the infrared detection element included in the imager 4 in this example is a so-called pyroelectric type infrared detection element using a pyroelectric element; however, the pyroelectric element generates electric charge depending on temperature variation (temperature difference), and thus it is necessary to intentionally generate a temperature difference in order to image even a motionless subject.

For this reason, the above-described shutter 2 and shutter driving unit 3 are provided. That is to say, the application and blocking of infrared rays from a subject to the imager 4 are alternately repeated by the shutter 2 and the shutter driving unit 3. Therefore, a temperature difference (a temperature difference between a temperature from a subject in an application state and a temperature from the shutter 2 in a blocking state) can be intentionally generated in each pixel (each infrared detection element), and thus it is possible to image a motionless subject as well as a moving subject.

The imager 4 includes a plurality of infrared detection elements which are formed by pyroelectric elements and are arranged on the imaging surface thereof.

As described later, each infrared detection element includes a pyroelectric element (a pyroelectric thin film 10 described later), and an upper electrode 11 and a lower electrode 12 with the pyroelectric element interposed therebetween, electric charge according to the “temperature difference” is generated in the pyroelectric element when infrared rays are applied and blocked by the shutter 2 and the shutter driving unit 3, and the electric charge undergoes electric charge/voltage conversion through the upper electrode and the lower electrode and then is detected.

An image signal obtaining unit 5 receives voltage signals (luminance values) which are obtained through the electric charge/voltage conversion in the respective infrared detection elements of the imager 4 as described above, and obtains an infrared captured image signal.

An image signal processing unit 6 performs a variety of image signal processes for the image capturing signal obtained by the image signal obtaining unit 5. For example, a black level correction, a pixel defect correction, an aberration correction, an optical shading correction, a lens distortion correction, a temperature adjustment, a calculation of a distance variation amount, coding, and the like are performed.

An output from the image signal processing unit 6 is sent to an external display (an image display device) of the imaging device via an interface (not shown).

### 1-2. STRUCTURES OF INFRARED DETECTION ELEMENT AND IMAGER

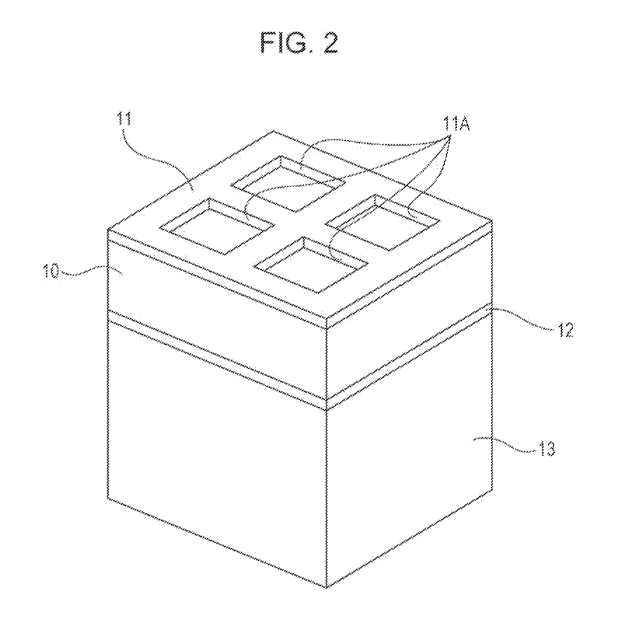

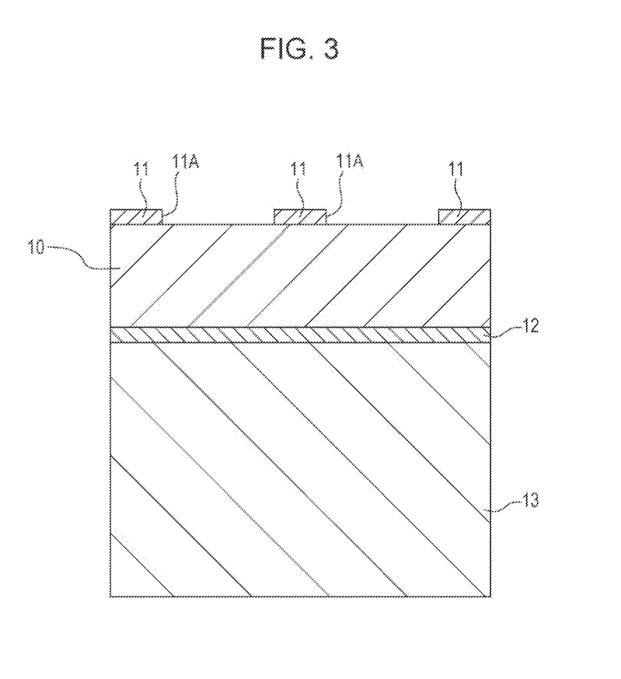

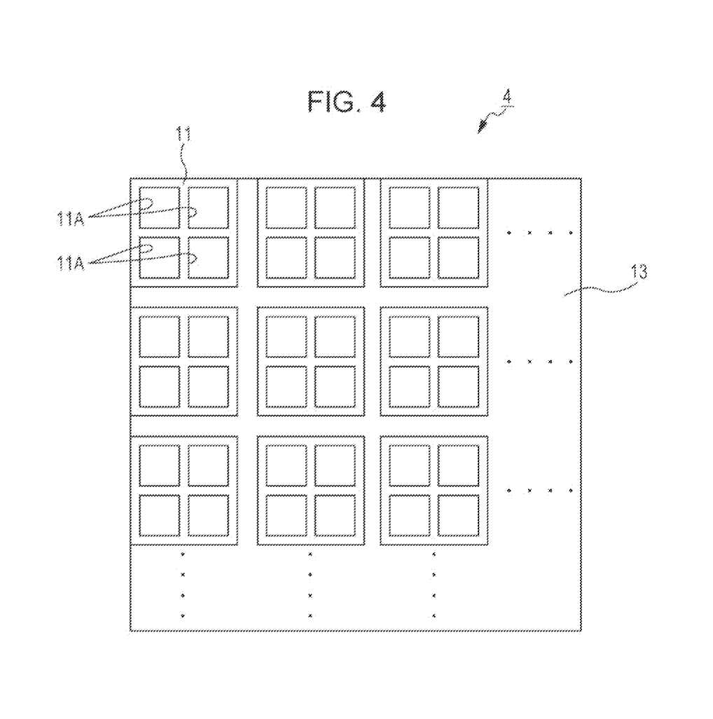

FIG. 2 is a perspective view of a structure of the infrared detection element according to a first embodiment; FIG. 3 is a cross-sectional structure view of the infrared detection element according to the first embodiment; and FIG. 4 is a plan view illustrating a structure of the imager 4.

As shown in FIGS. 2 and 3, the infrared detection element according to the embodiment includes a pyroelectric thin film 10 as a pyroelectric element, an upper electrode 11, a lower electrode 12, and a substrate 13. Specifically, they are formed in an order of the upper electrode 11, the pyroelectric thin film 10, the lower electrode 12, and the substrate 13 from the upper layer side.

Here, in the present specification, the “upper layer side” indicates an upper layer side of when the surface (the above-described imaging surface) to which infrared rays are incident from a subject is set to an upper surface.

The pyroelectric thin film 10 is made of a pyroelectric material where a value of spontaneous polarization is varied due to variations in temperature by absorbing infrared rays. In addition, a pyroelectric material is not particularly limited, and may employ, for example, lead titanate, lead zirconate titanate, and lithium tantalite, as inorganic materials, and triglycine sulfate (TGS) and polyvinylidene difluoride as organic materials.

The upper electrode 11 and the lower electrode 12 are made of a conductive material. The material of the upper electrode 11 and the lower electrode 12 may include, for example, Pt, Ti, Cr, Al, Au, Cu, or the like.

In the embodiment, the upper electrode 11 is provided with opening portions 11A. The opening portions 11A are formed so as to expose a part of the underlying pyroelectric thin film 10 to outside. That is to say, the thickness of the upper electrode 11 at the parts where the opening portions 11A are formed is zero.

In this example, four opening portions 11A are formed for each infrared detection element (each pixel). In addition, the shape of each of the opening portions 11A is rectangular.

As shown in FIG. 4, in the imager 4, a plurality of units (pixels) each formed by “the upper electrode 11, the pyroelectric thin film 10, and the lower electrode 12” are arranged on the substrate 13 independently. A face on which the upper electrode 11 is formed is a surface (imaging surface) of the imager 4.

### 1-3. OPERATION AND EFFECTS

Here, since the pyroelectric thin film 10 generates surface charge through variations in spontaneous polarization caused by a temperature variation occurring when infrared rays are absorbed, an output corresponding to only the area interposed between the upper and lower electrodes can be obtained. Therefore, in order to increase sensitivity by absorbing more infrared rays, typically, the upper electrode 11 is formed as widely as possible.

However, generally, the reflectance of infrared rays of a metal exceeds 90%, and if the metal is used as an electrode as it is, 90% or more of input infrared ray energy is reflected, and thus the energy may not be sufficiently used for a temperature variation of the pyroelectric thin film 10 located under the upper electrode 11.

Thus, in the embodiment, a part of the pyroelectric thin film 10 is exposed to the upper surface side by providing the above-described opening portions 11A.

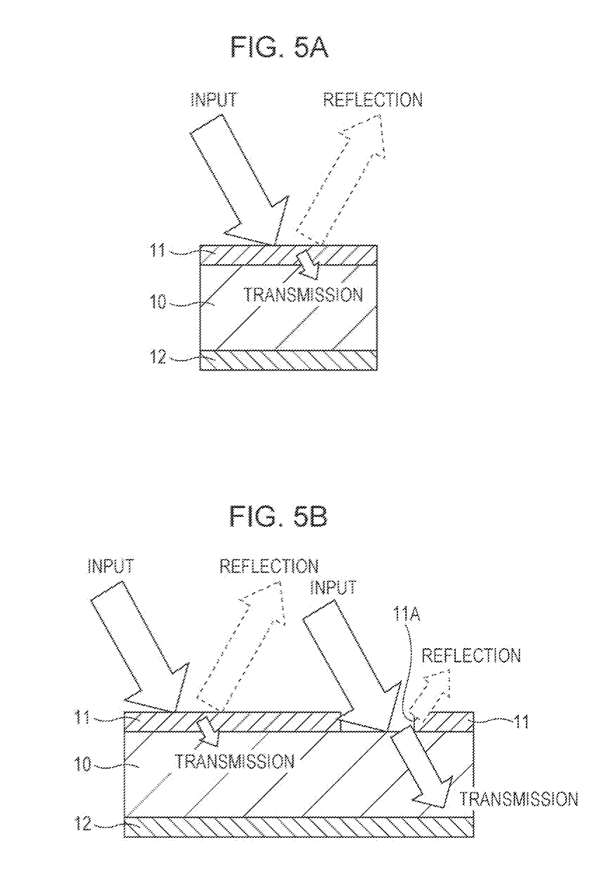

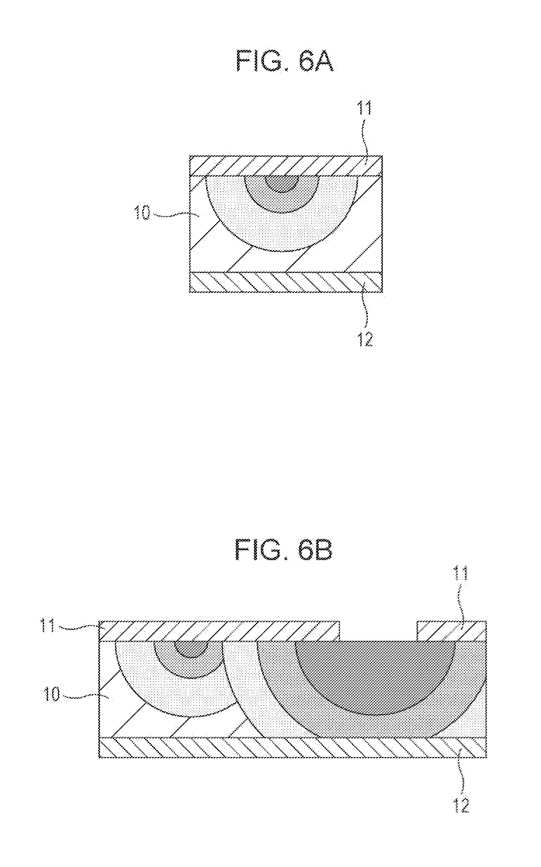

FIGS. 5A and 5B schematically show a form of transmission and reflection of infrared rays when the opening portion 11A is absent (FIG. 5A) and a form of transmission and reflection of infrared rays when the opening portion 11A is provided (FIG. 5B), and FIGS. 6A and 6B schematically show a form of heat conduction when the opening portion 11A is absent (FIG. 6A) and a form of heat conduction when the opening portion 11A is provided (FIG. 6B).

In addition, in FIGS. 6A and 6B, heat quantity is denoted with light and shade of colors, and the shaded color indicates large heat quantity.

As can be seen from FIGS. 5A and 5B, the pyroelectric thin film 10 is exposed at the parts where the opening portions 11A are formed on the upper electrode 11, and thus infrared rays which are originally reflected by the upper electrode 11 can be transmitted through the pyroelectric element, thereby further increasing an amount of the infrared rays reaching the pyroelectric thin film 10.

In addition, along therewith, as shown in FIGS. 6A and 6B, an amount of infrared ray energy reaching the pyroelectric thin film 10 is also increased when the opening portions 11A are provided.

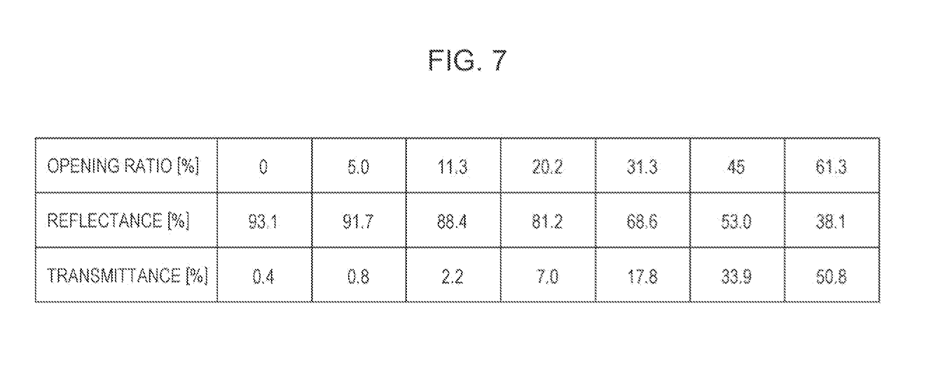

FIG. 7 shows a relationship between an opening ratio, and transmittance and reflectance of infrared rays as a table. In addition, FIG. 7 shows a simulation result when Pt is used as a material of the upper electrode 11, the film thickness thereof is set to 30 nm, and the pixel size is set to 17 μm×17 μm.

In FIG. 7, it can be seen that as the opening ratio of the upper electrode 11 (a ratio taken by the opening portions 11A on the upper electrode 11) is increased, the reflectance is reduced, and, to the contrary, the transmittance is increased.

Meanwhile, a temperature variation amount ΔT is generally obtained by the following Equation 1.

$$Δ T = \frac{η P}{\sqrt{G + {( ω H )}^{2}}} \qquad ( 1 )$$

Here, η: absorption ratio of infrared rays, P: incident heat quantity of infrared rays, G: thermal conductance of the element, ω: chopping frequency (period of application/blocking by the shutter 2), and H: heat capacity of the element.

Here, the incident heat quantity of infrared rays P is defined by the reflectance and transmittance of infrared rays shown in FIG. 7, and energy of infrared rays input to the pyroelectric element is increased according to an increase in the transmittance, and thus the temperature variation amount becomes larger.

In addition, an output ΔV of the pyroelectric element is defined by the following Equation 2.

$$Δ V = ω \cdot A \cdot λ \cdot \frac{R}{\sqrt{1 + {( ω τ )}^{2}}} \cdot Δ T \qquad ( 2 )$$

Here, A: electrode area, λ: pyroelectric coefficient, R: resistance value for electric charge/voltage conversion, and τ: electric time constant.

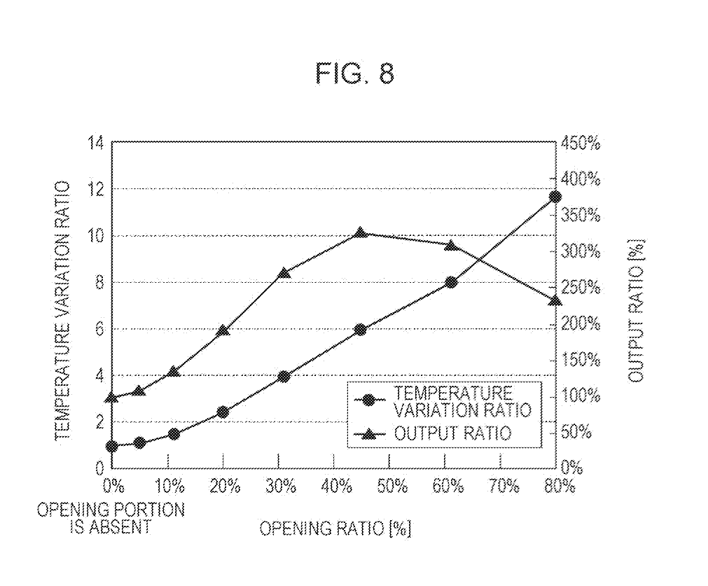

FIG. 8 shows a relationship between the temperature variation ratio and the output ratio with respect to the opening ratio of the upper electrode 11, obtained according to Equation 1 and Equation 2.

As can be seen from FIG. 8, as the opening ratio is increased, the temperature variation ratio (a temperature difference between irradiation and blocking) is increased. However, if the opening ratio is large, the area A of the upper electrode 11 is small, and thus if the opening ratio is excessive, high sensitivity disappears. This is clear from Equation 2.

According to FIG. 8, if the opening ratio is about 30% to 70%, the output can be improved by 2.5 times or more as compared with that in the related art (the ratio when the opening portion 11A is absent).

In addition, if the opening ratio is about 45%, the output can be increased to the maximum (three times higher than that in the related art).

From this, the opening ratio is preferably 30% to 70%, and most preferably is about 45%.

As described above, according to the embodiment, the opening portions 11A are provided on the upper electrode 11, and thus it is possible to realize high sensitivity in the infrared detection element.

In addition, the opening portions 11A can be formed with a simple process in which, for example; a laminated structure formed of “the substrate 13, the lower electrode 12, the pyroelectric thin film 10, and the upper electrode 11”, and etching is performed for the upper electrode 11. As can be seen from this, according to the embodiment, it is possible to realize high sensitivity in the infrared detection element while preventing the manufacturing process from being complicated.

### 2. SECOND EMBODIMENT

Here, as described above, the opening portions 11A can be formed with a simple process such as performing etching for the upper electrode 11. Specifically, a formation process of the opening portions 11A may include a method of etching the upper electrode 11 through ion milling.

However, in the ion milling, ions physically collide with each other and thus are forced to impact the surface of the pyroelectric thin film 10. As a result, the polarization characteristic of the pyroelectric thin film 10 may be deteriorated.

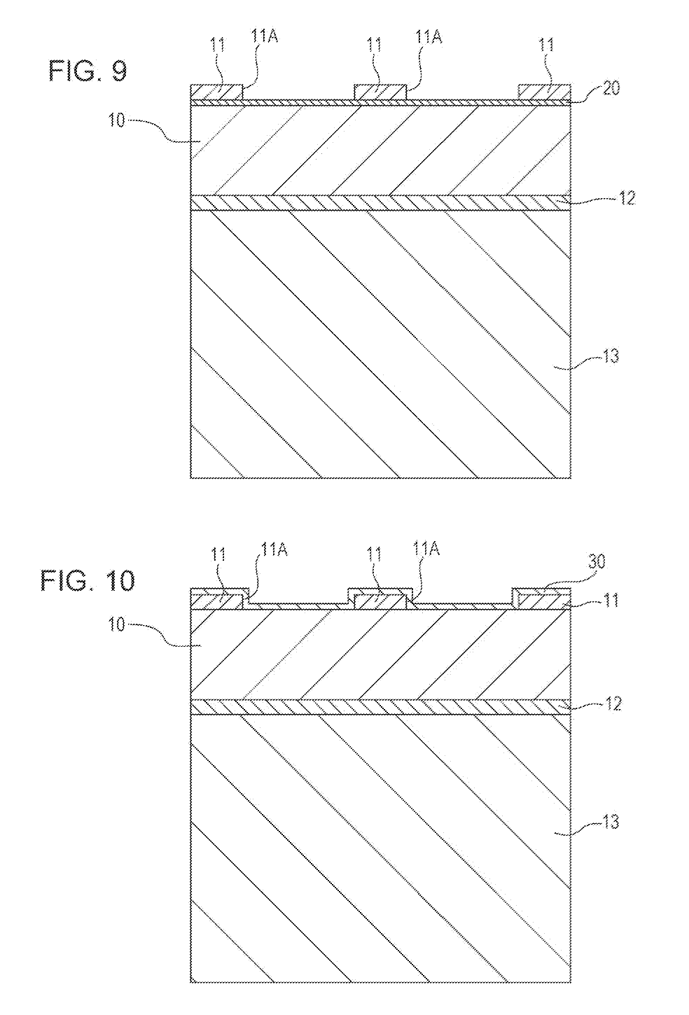

Therefore, as an infrared detection element according to the second embodiment, an infrared detection element having a structure as shown in FIG. 9 is proposed.

In addition, FIG. 9 shows a cross-sectional structure of the infrared detection element according to the second embodiment.

In addition, in the second embodiment, configurations other than the infrared detection element in the imaging device are the same as those described in the first embodiment, and thus repeated description will be omitted.

In FIG. 9, the infrared detection clement according to the second embodiment includes an upper electrode 11, a protective transmission film 20, a pyroelectric thin film 10, a lower electrode 12, and a substrate 13 from the upper layer side in this order. That is to say, the protective transmission film 20 is disposed between the upper electrode 11 and the pyroelectric thin film 10 in the infrared detection element according to the first embodiment.

As such, the protective transmission film 20 is formed between the upper electrode 11 and the pyroelectric thin film 10, and thus it is possible to effectively prevent the pyroelectric thin film 10 from being deteriorated during the ion milling.

At this time, the protective transmission film 20 employs a conductive material. In addition, a material having the high transmittance of infrared rays is preferably selected. An example thereof may include Ti or Cr.

Further, if the protective transmission film 20 is formed between the upper electrode 11 and the pyroelectric thin film 10 as above, since selectivities for different kinds of metals by the ion milling are different from each other, an effect that etching can be completed at the upper side of the protective transmission film 20 is achieved.

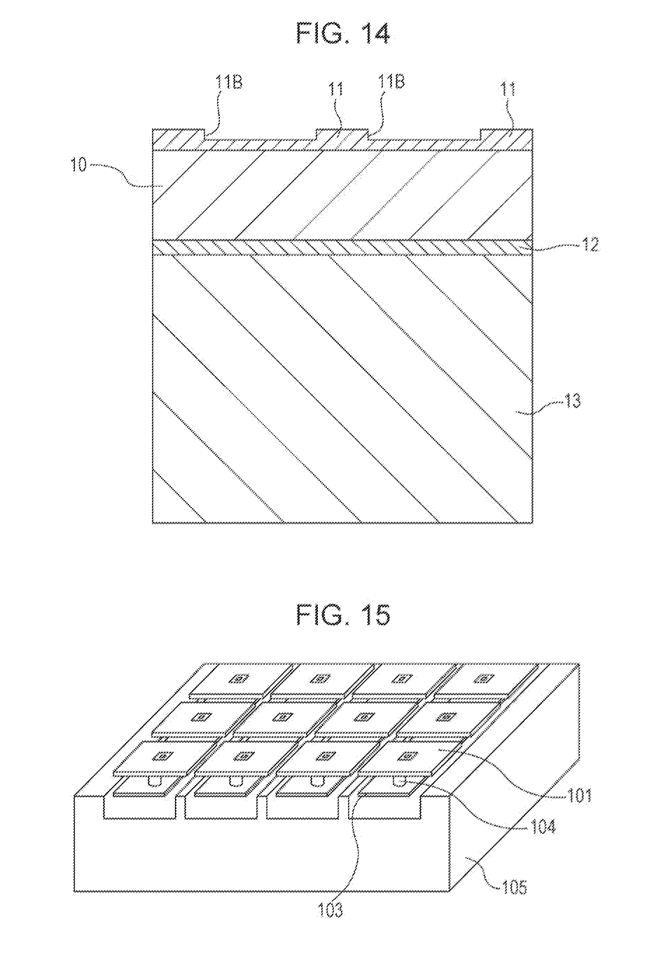

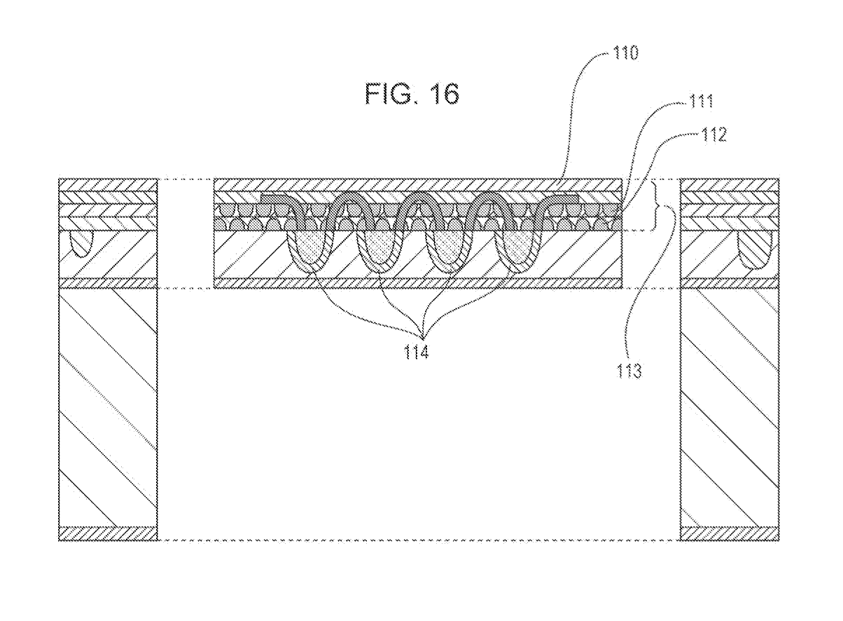

Here, in order to prevent characteristics of the pyroelectric thin film 10 from being deteriorated due to the etching, a method may be employed in which the upper electrode 11 is not completely penetrated but a part thereof is left (for example, refer to FIG. 14). In the second embodiment, the reason why the protective transmission film 20 is provided, that is, the upper electrode 11 is not formed using only Ti or Cr having the high transmittance of infrared rays is as follows.

1) Ti or Cr is combined with oxygen in an atmosphere and becomes TiO₂ or CrₓO_{y}.

The oxides, the titanium oxide and the chromium oxide have very high electric contact resistance and thus there is concern that they may not be suitable to be used for an electrode.

2) For example, if the pyroelectric thin film 10 is formed with the thickness of 1 μm or more, the surface roughness of the upper side becomes 100 nm or more. In this case, if the upper electrode 11 is to be formed without cracks, the film thickness of 100 nm or more is necessary. If the film thickness is 100 nm or more, even Ti or Cr having high transmittance has transmittance of far infrared rays of 10% or less.

For these reasons, a material having relatively good transmittance of far infrared rays is used for the protective transmission film 20, and, for example, a material such as Pt which originally has a stable electric characteristic is preferably used for the upper electrode 11.

As described above, according to the second embodiment, by forming the protective transmission film 20 between the upper electrode 11 and the pyroelectric thin film 10, it is possible to effectively prevent the pyroelectric thin film 10 during the ion milling.

In addition, the selectivities for different kinds of metals by the ion milling are different from each other, and thus the effect that etching can be completed at the upper side of the protective transmission film 20 is achieved.

In addition, if an etching amount of the upper electrode 11 by the ion milling can be controlled with high accuracy, there is no problem even in the structure according to the first embodiment.

### 3. THIRD EMBODIMENT

FIG. 10 shows a cross-sectional structure of an infrared detection element according to a third embodiment.

As can be seen through comparison with FIG. 3, the infrared detection element according to the third embodiment includes an absorption film 30 formed on the upper surface side of the upper electrode 11 in the infrared detection element according to the first embodiment.

The absorption film 30 is made of a material capable of absorbing infrared rays.

With this structure, it is possible to improve infrared detection sensitivity by both operations, that is, an increase in the transmittance of infrared rays through the provision of the opening portions 11A and an increase in the heat absorption ratio through the provision of the absorption film 30.

### 4. MODIFIED EXAMPLE

As above, although the respective embodiments have been described, the present application is not limited to the detailed examples described hitherto but may employ various configurations in the scope not departing from the spirit of the present application.

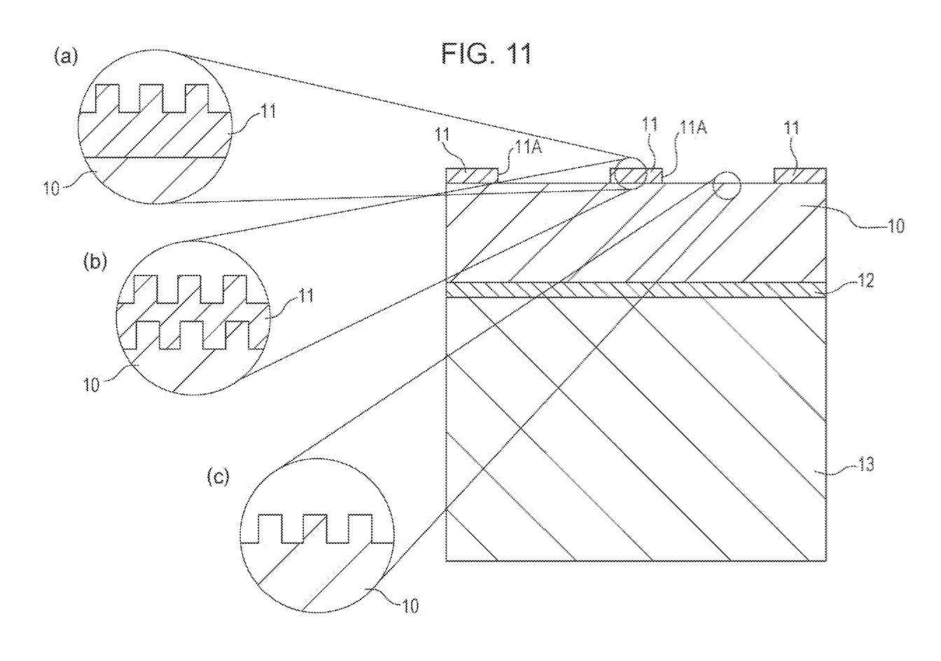

For example, in order to further increase an absorption ratio of infrared rays, a structure as shown in FIG. 11 may be employed as a modified example 1.

FIG. 11 shows the overall cross-sectional structure of the infrared detection element in the right part thereof (equal to the overall cross-sectional structure of the infrared detection element according to the first embodiment), wherein A and B of FIG. 11 are enlarged views of parts where the upper electrode 11 is formed, and C of FIG. 11 is an enlarged view of a part which is exposed (opened) by the opening portion 11A in the pyroelectric thin film 10.

As shown in (a), (b) and (c) of FIG. 11, fine concavities and convexities are given to at least one of the upper surface of the upper electrode 11, both of the upper surface of the upper electrode 11 and the upper surface of the pyroelectric thin film 10, and the parts opened by the opening portions 11A of the pyroelectric thin film 10. Specifically, concavities and convexities having at least a pitch which is equal to or less than a wavelength of the targeted infrared ray are given. For example, the concavities and convexities preferably have the surface roughness of about 100 nm to 5 μm.

With the structure having the fine concavities and convexities, in relation to wavelengths in a far infrared region, phases of a wavelength of an incident infrared ray and a wavelength of a reflected infrared ray are reversed by the concavities and convexities, thereby promoting reduction in reflectance (increase in transmittance) of the infrared rays.

As a result, heat can be efficiently absorbed, and thus infrared detection sensitivity can be further improved.

In addition, although a fine concave and convex structure is employed in the infrared detection element according to the first embodiment in FIG. 11, the concave and convex structure may be employed in the infrared detection elements according to the second and third embodiments.

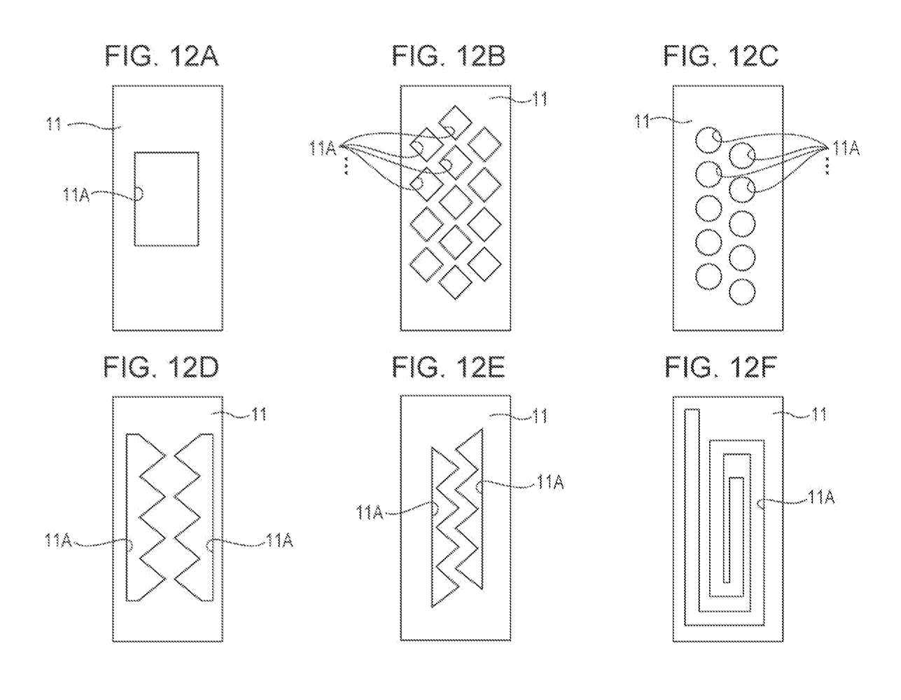

In addition, although a case where the opening portions 11A are rectangular and four opening portions 11A are formed on the upper electrode 11 has been exemplified in the above description, a pattern of the opening portions 11A formed on the upper electrode 11 is not limited thereto, but may be various patterns as shown in FIGS. 12A to 12F.

In FIGS. 12A to 12F, FIG. 12A shows a pattern where one rectangular opening portion 11A is formed in the center of the upper electrode 11, FIG. 12B shows a pattern where a plurality of diamond-shaped opening portions 11A are formed, and FIG. 12C shows a pattern where a plurality of circular opening portions 11A are formed.

In addition, FIG. 12D shows a pattern where two opening portions 11A having edges of a zigzag shape are arranged such that the vertices of the zigzag are opposite to each other, and FIG. 12E shows a pattern where two opening portions 11A having of a zigzag shape are arranged such that the vertices of the zigzag are misaligned with each other.

Further, FIG. 12F shows a pattern where thin and long opening portions 11A are formed in a spiral shape.

In addition, the shapes and the formed patterns of the opening portions 11A are only an example, and other shapes and formed patterns may be employed.

Any one efficiently causes a temperature variation in the pyroelectric thin film 10, and thus the circumference of the opening portion is preferably as long as possible.

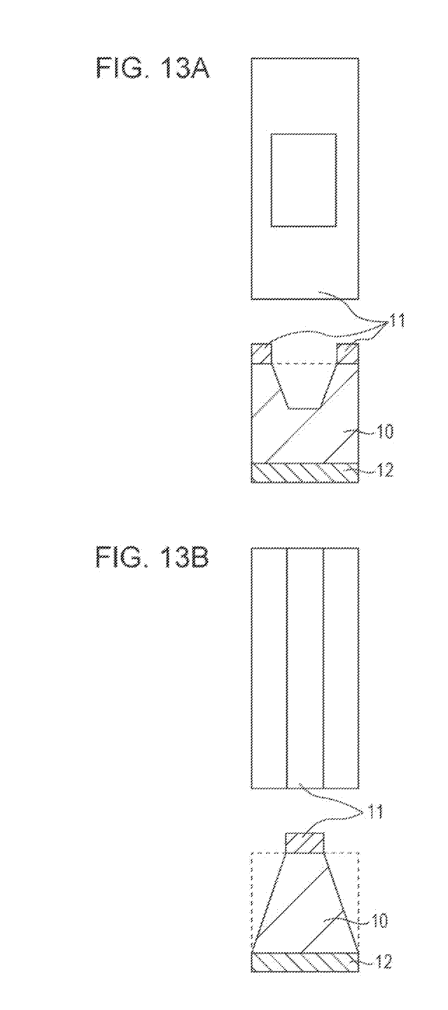

Further, a taper may be formed in the pyroelectric thin film 10 as shown in FIGS. 13A and 13B from the viewpoint of increasing the area for sensing infrared rays of the pyroelectric thin film 10 as much as possible (modified example 2).

FIG. 13A shows an example where a taper is formed at the part opened by the opening portion 11A in the pyroelectric thin film 10, so as to correspond to the case where the opening portion 11A is provided in the center of the upper electrode 11.

In addition, FIG. 13B shows an example where a taper is formed at parts other than the part where the upper electrode 11 is formed on the pyroelectric thin film 10, so as to correspond to a case where the opening portion 11A is not formed on the upper electrode 11, and the upper electrode 11 is disposed only in the center of the pyroelectric thin film 10.

FIG. 14 shows an example where concave portions 11B are formed on the upper electrode 11 instead of the opening portions 11A, as an infrared detection element according to a modified example 3.

The concave portions 11B are formed by thinning the upper electrode 11, and, for example, are formed such that the upper electrode 11 is not penetrated but is partially left by etching the upper electrode 11.

An amount of infrared rays to be transmitted to the pyroelectric thin film 10 is increased at the parts thinned by the formation of the concave portions 11B, and thus it is possible to realize high sensitivity in an infrared detection element in the same principle as that in the case where the opening portion 11A is provided.

In addition, in the structure where the concave portions 11B are formed, it is possible to prevent an impact on the pyroelectric thin film 10 during etching and thus to prevent deterioration in the pyroelectric thin film 10.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An infrared detection element comprising:
a pyroelectric element;
an upper electrode and a lower electrode located so as to have a positional relationship where the pyroelectric element is interposed therebetween; and
an opening function portion formed on the upper electrode such that a film thickness of the upper electrode is small or zero.

2. The infrared detection element according to claim 1, wherein an opening ratio of the upper electrode by the opening function unit is approximately 30% to 70%.

3. The infrared detection element according to claim 2, wherein the upper electrode is made of one of Pt, Ti, Cr, Al, Au, and Cu.

4. The infrared detection element according to claim 3, further comprising a protective transmission film disposed between the pyroelectric element and the upper electrode.

5. The infrared detection element according to claim 4, wherein the protective transmission film is made of Ti or Cr.

6. The infrared detection element according to claim 5, further comprising an infrared absorption film on the upper surface of the upper electrode.

7. The infrared detection element according to claim 1, wherein concavities and convexities having at least a pitch which is equal to or less than a wavelength of an infrared ray set as a detection target are given to at least a region opened by the opening function portion in the upper surface of the pyroelectric element, or the upper surface or the lower surface of the upper electrode.

8. The infrared detection element according to claim 1, wherein the number of the opening function portion formed on the upper electrode is one.

9. The infrared detection element according to claim 1, wherein the opening function portion is formed in plurality on the upper electrode.

10. The infrared detection element according to claim 1, wherein the opening function portion is formed such that the thickness of the upper electrode is zero.

11. The infrared detection element according to claim 1, wherein the opening function portion is a concave portion which thins the upper electrode.

12. The infrared detection element according to claim 1, wherein the pyroelectric element is tapered.

13. An infrared imaging device comprising:
an imaging element that includes a plurality of infrared detection elements which are arranged in an imaging surface;
an imaging optical system that collects infrared rays at the imaging surface; and
an image signal obtaining unit that obtains an infrared captured image signal based on a result of detecting electric charge obtained by the infrared detection element according to the collection of the infrared rays,
wherein the infrared detection element of the imaging element includes a pyroelectric element; an upper electrode and a lower electrode located so as to have a positional relationship where the pyroelectric element is interposed therebetween; and an opening function portion formed on the upper electrode such that a film thickness of the upper electrode is small or zero.
